(19) United States
(12) Patent Application Publication
(10) Pub. No.: US 2010/0039682 A1
(43) Pub. Date: Feb. 18, 2010

(54) Systems And Arrangements For Object Identification

(75) Inventors: Paul R. Peot, N. Mequon, WI (US); David Alun James, Duxford (GB); Mark Johnson, Lymm (GB); Graham Lodge, Needingworth (GB); Rupert Menzies, Milton (GB)

Correspondence Address: CALFEE, HALTER & GRISWOLD LLP, 1400 KEYBANK CENTER, 800 SUPERIOR AVENUE, CLEVELAND, OH, 44114, US

(73) Assignee: WATERLOO INDUSTRIES, INC., Oak Creek, WI (US)

(21) Appl. No.: 12/542,934

(22) Filed: Aug. 18, 2009

Related U.S. Application Data
(60) Provisional application No. 61/089,602, filed on Aug. 18, 2008.

(51) Int. Cl. H04N 1/04

(52) U.S. Cl. 358/474

(57) ABSTRACT

An object identifying system includes an optical scanning device configured to record a series of linear images of successive portions of a support surface as the support surface is moved between first and second positions. A processor in electrical communication with the optical scanning device is configured to compile data corresponding to the series of linear images of the successive portions of the support surface to construct a digital image of the support surface. The processor is configured to compare the digital image of the support surface to at least one stored digital image of a known object to identify an object when the object is disposed on the support surface.

### CROSS-REFERENCE TO RELATED APPLICATION

This application claims the benefit of U.S. Provisional Patent Application Ser. No. 61/089,602, entitled SYSTEMS AND ARRANGEMENTS FOR OBJECT IDENTIFICATION and filed Aug. 18, 2008, the entire disclosure of which is incorporated herein by reference, to the extent that it is not conflicting with the present application.

### BACKGROUND

Loss of inventory, for example, due to theft or misplacement, is a concern in many settings, including, for example, retail establishments or workplace settings in which maintaining a full inventory of the necessary tools and devices may be critical (such as maintenance tools for vehicles or manufacturing equipment). In some applications, objects not returned to inventory (e.g., a storage cabinet) may additionally cause harm (such as aviation tools accidentally left on board an aircraft). Electronic inventory tracking systems have been utilized to provide visibility of changes in overall inventory levels or the presence or location of specific individuals items. In one such conventional system, radio frequency identification (RFID) transponders or “tags” may be affixed to items to receive and transmit radio signals delivered by a reader, which identifies the presence of the tagged item by processing the signal returned by the RFID tag. Such systems may require affixation of RFID tags to many items, which may be expensive, and may be vulnerable to damage to the tag or inadvertent or unauthorized separation of the tag from the item.

### SUMMARY

The present application describes electronic object identifying arrangements which may be utilized to identify objects placed in an enclosure (e.g., a cabinet, tray, or storage box), for example, to confirm proper storage of the objects, to alert a user of missing objects, or to identify the storage of incorrect objects or objects stored in incorrect locations. According to an inventive aspect of the present application, one or more optical scanners may be utilized to scan a storage space or support surface on which one or more objects have been placed. The captured data corresponding to the scanned images may then be compared to stored data or templates to identify stored objects or the absence of stored objects on the support surface. A user interface or other output may be provided to provide a confirmation that objects have been properly stored, or an alert that objects are missing or improperly stored.

Accordingly, in one embodiment, an object identifying system includes an enclosure and a drawer including a support surface for retaining at least one object, the drawer being assembled with the enclosure and movable between a retracted position in which the support surface is surrounded by the enclosure and an extended position in which the support surface extends from a front opening of the enclosure and is accessible for placement or removal of the at least one object. An optical scanning device disposed within the enclosure proximate a rear wall of the enclosure, and a mirror is secured to the enclosure proximate the front opening and above the support surface of the drawer, the mirror being oriented to redirect light reflected from a portion of the support surface under the mirror toward the optical scanning device. The optical scanning device is configured to record a series of linear images of successive portions of the support surface under the mirror when the drawer is moved between the retracted position and the extended position. A processor in electrical communication with the optical scanning device is configured to compile data corresponding to the series of linear images of the successive portions of the support surface to construct a digital image of the support surface, the processor further being configured to compare the digital image of the support surface to at least one stored digital image of a known object to identify an object when the object is disposed on the support surface.

### BRIEF DESCRIPTION OF THE DRAWINGS

Features and advantages of the invention will become apparent from the following detailed description made with reference to the accompanying drawings, wherein:

FIG. 1A is a schematic block diagram of an electronic object identifying arrangement;

FIG. 1B is a side schematic view of a cabinet having an optical scanning arrangement for object identification;

FIG. 2A is a lower perspective view of a storage cabinet having an optical scanning arrangement for object identification, shown with a drawer removed to illustrate additional features of the cabinet;

FIG. 2B is a partial perspective view of the cabinet of FIG. 2A, illustrating a lighting unit of the cabinet;

FIG. 2C is a side cross-sectional view of the cabinet of FIG. 2A, illustrating a lighting unit and mirror element of the cabinet;

FIG. 2D is another partial perspective view of the cabinet of FIG. 2A, illustrating a lighting unit and mirror element of the cabinet;

FIG. 3A is a perspective view of an optical scanner assembly;

FIG. 3B is a side cross-sectional view of the optical scanner assembly of FIG. 3A;

FIG. 3C is a top view of the optical scanner assembly of FIG. 3A, shown mounted to a support panel;

FIG. 3D is a side view of the optical scanner and support panel assembly of FIG. 3C;

FIG. 3E is a perspective view of the optical scanner and support panel assembly of FIG. 3C;

FIG. 4A is a front view of left and right support panels assembled with multiple optical scanner assemblies;

FIG. 4B is a partial top view of the left and right support panel assemblies of FIG. 4A, shown mounted in a cabinet enclosure;

FIG. 5A is a top schematic view of an optical scanner assembly and drawer arrangement, with the drawer being configured to facilitate optical scanning;

FIG. 5B is an enlarged view of an encoded calibration strip for use with the drawer of FIG. 5A;

FIG. 5C is a top schematic view of an optical scanner assembly and drawer arrangement using multiple scanners; and

FIG. 6 is a perspective view of a housing and electrical subsystem of an optical scanning cabinet with the housing shown in phantom to illustrate additional features of the cabinet.

### DETAILED DESCRIPTION

This Detailed Description merely describes embodiments of the invention and is not intended to limit the scope of the claims in any way. Indeed, the invention as claimed is broader than and unlimited by the preferred embodiments, and the terms used in the claims have their full ordinary meanings.

The present application contemplates an object identification system in which one or more visual characteristics of an object or objects within a storage enclosure (such as, for example, a cabinet, box, or shelf) are obtained (for example, by an optical scanner or camera) to identify and/or track these objects. Many different types of visual characteristics may be recorded or measured, including, for example, partial or overall shape, orientation, color, contrast, marked patterns (including, for example, character strings, logos, and bar codes), and reflectivity. In one such embodiment, data signals associated with one or more visual characteristics are produced by an optical scanner or camera and supplied to a processor (which may, but need not, be retained within the enclosure) for analysis. Electronic analysis of these visual characteristics may, for example, provide confirmation that all objects have been returned to the container (or an alert that one or more objects are missing), identify new or different objects stored in the container, identify the storage of an object in an incorrect location within the container, or recognize a change in the condition of an object (e.g., depletion or damage). According to one aspect of the present application, a system may be configured to identify an item or items by comparing an image obtained of an object or objects present with an existing image corresponding to storage of the object or objects.

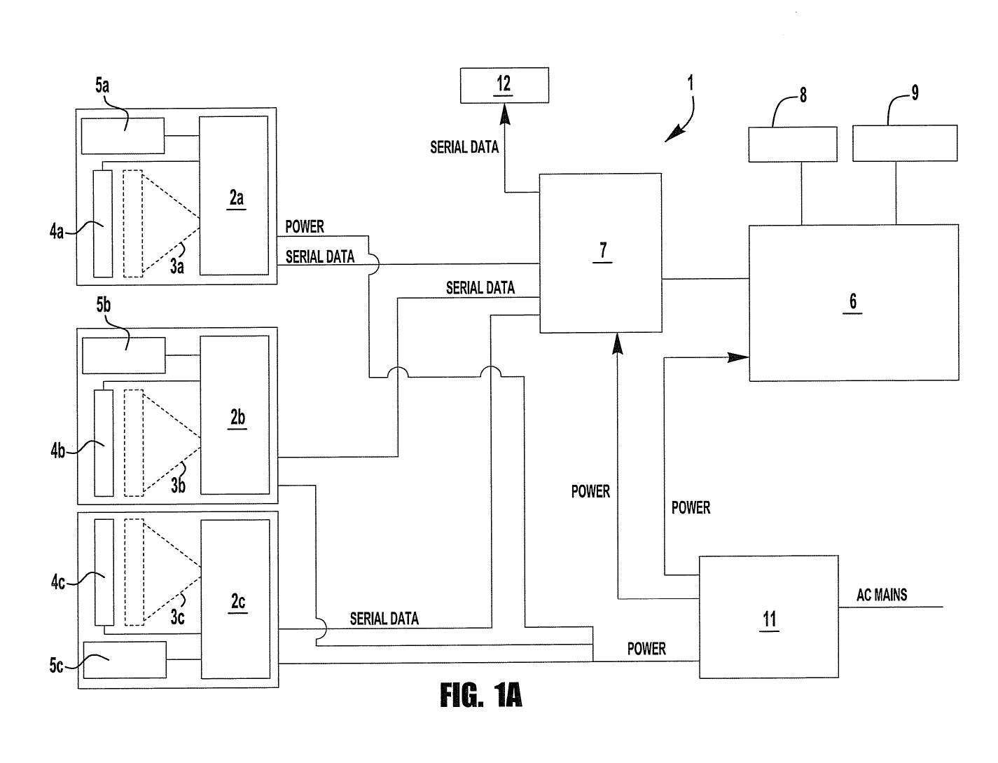

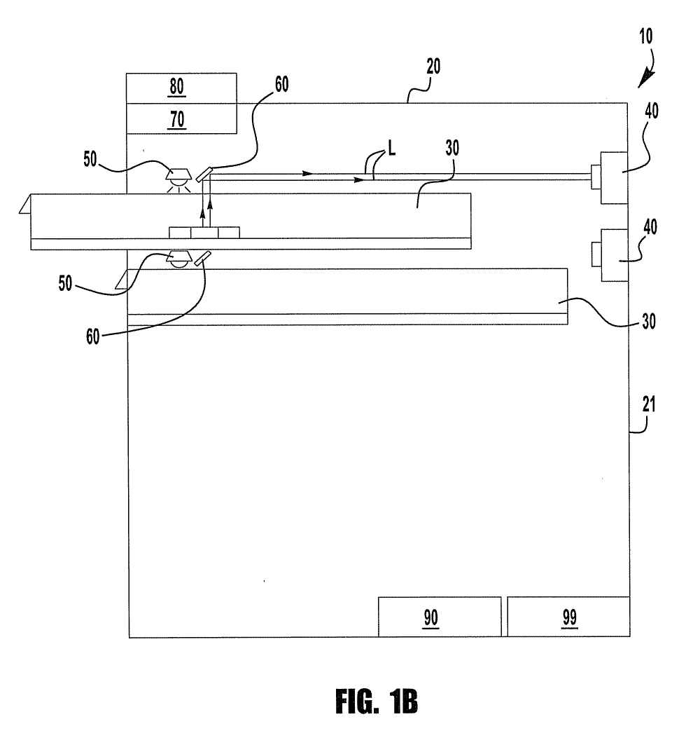

FIG. 1A schematically illustrates an electronic object identifying arrangement 1 in accordance with inventive aspects of the present application. The exemplary arrangement 1 includes scanning modules 2a, 2b, 2c that utilize optics (e.g., lenses, mirrors) 3a, 3b, 3c to record images of a storage space (e.g., a drawer, tray, or other enclosure) illuminated by a light source 4a, 4b, 4c). Each scan module may be connected to user indicator LEDs or other interface displays 5a, 5b, 5c to indicate a condition of the scanning module 2a, 2b, 2c (e.g., successful or unsuccessful scan). The scanning modules 2a, 2b, 2c are in electrical communication with a central digital signal processor (DSP) 6 through a network switch or hub 7, which routes serial data between the scanning modules 2a, 2b, 2c and the DSP 6. Image data delivered to the DSP 6 from the scanning modules 2a, 2b, 2c may be evaluated by the DSP and compared to stored templates and existing image date, for example, to identify objects retained in the storage space, to identify objects missing from the storage space, or to identify objects in the storage space that have changed in appearance (e.g., due to depletion or damage). Additionally or alternatively, image data associated with new objects or new layouts of objects may be stored as new images or templates, which may be identified by user inputs, for use in future image scan evaluations. This may allow the arrangement 1 to be used as a standalone system, without requiring external software to identify tools or portions of templates to be analyzed. The ability of the arrangement 1 to learn new objects or object layouts allows for greater adaptability in identifying swapped drawers, replacement objects, rearranged objects, and objects placed in different positions and orientations (e.g., objects that are flipped over).

Each scanning module 2a, 2b, 2c may be uniquely coded for identification by the DSP 6. Additional data or instructions may be provided to the DSP 6 by a user using a keypad or other such interface 8, and information may be communicated to the user by a text display, video screen, or other such display 9. A system power supply 11 may be configured to convert external AC power to appropriate DC power for the scanning modules 2a, 2b, 2c (e.g., 24 VDC), light sources 4a, 4b, 4c (e.g., 24 VDC), DSP 6 (e.g., 5 VDC), and network hub 7 (e.g., 12 VDC).

Many different arrangements may be utilized to obtain an image of the contents of an enclosure. As one example, one or more cameras or scanners may be provided within the enclosure to record a static image of a storage area in which one or more objects are to be stored. As another example, one or more optical scanners may be configured to move across a storage area (e.g., sliding movement, like a document scanner, or pivoting movement, like a security camera) to obtain a two dimensional image of the storage area and its contents. As still another example, a storage area may be moved with respect to one or more stationary optical sensors to obtain a two dimensional image of the storage area and its contents. In one such embodiment, a storage cabinet includes one or more optical scanners or sensors configured to scan the internal surface (and contents) of a drawer as the drawer is opened or closed, thereby obtaining a two dimensional image of the storage area and its contents.

A cabinet may be provided with one or more optical scanners in a variety of positions and orientations to scan the contents of a drawer as the drawer is opened or closed. As one example, one or more optical scanners may be attached to an outer surface of the cabinet to scan a portion of a drawer protruding from the cabinet enclosure. A scanner attached to (or adjacent to) an upper front edge of the cabinet may be used to scan the contents of multiple drawers within the cabinet as the drawers are opened or closed, provided only one drawer extends from the cabinet at a given time. In another embodiment, one or more optical scanners may be secured within the cabinet enclosure, which may prevent the scanners from being exposed to damage or contamination. While the scanners may be secured above one or more drawers to scan the internal surfaces of the drawers as the drawers pass directly below the scanners, space limitations may make such positioning difficult or expensive (as longer or additional scanners may be required to scan objects positioned so close to the scanners). In one embodiment, one or more scanners may be configured to optically scan a portion of the drawer longitudinally spaced from the scanner, by utilizing a mirror to direct an optical image of the portion of the drawer longitudinally back to the scanner. This technique may allow the scanners to be positioned in the cabinet in an area where more space is available (e.g., proximate to a rear wall of the cabinet), and may also allow smaller or fewer scanners to obtain an image of a wider portion of the drawer.

FIG. 1B illustrates a side schematic view of an exemplary storage cabinet 10 configured for optical scanning of the contents of one or more drawers 30 for identifying and/or tracking the contents of the drawers. The exemplary cabinet 10 includes an external housing or enclosure 20 and a drawer 30 slidably supported by the housing 20 (for example, using conventional drawer slides) for movement between closed and opened positions. An optical scanner assembly 40 is mounted to a rear wall 21 of the housing 20, and is sized to provide clearance with a rear end of the corresponding drawer 30 when the drawer is in the closed position. The optical scanner assembly 40 may be compact in size (e.g., approximately 50 mm×100 mm) to fit in the available spaces within the cabinet 10.

To obtain an image of the corresponding drawer 30, a lighting unit 50 and a mirror element 60 are secured to the cabinet housing 20 above the drawer 30 to be scanned and toward the front of the housing 20. The lighting unit 50 illuminates the inside of the drawer 30, while the mirror element 60 is angled to direct a linear image (represented schematically by lines I) of the portion of the drawer directly below the mirror element 60 towards the optical scanner assembly 40. In another embodiment (not shown), an optical scanning system may include a upward oriented scanner and a second mirror above the scanner to re-direct the linear image reflected from the first mirror downward towards the second mirror.

As the drawer 30 is moved between opened and closed positions, the scanner assembly 40 receives and records a sequential series of digital linear images of the drawer 30. These digital signals are communicated from the optical scanner assembly 40 (for example, via a network hub 99) to a digital signal processor (DSP) 70 stored within the housing. The DSP 70 uses the data received to construct a two dimensional image of at least a portion of the drawer 30. The DSP 70 may then compare all or part of this image to known images corresponding to one or more objects, to identify the presence, absence, position, or condition of these objects within the drawer 30. Signals associated with the results of this comparison may then be sent to a user interface 80 to provide a visual, audible, or other such cue to the user regarding the contents of the drawer 30. A system power supply 90 may be provided within the housing 20 to convert external AC power to DC power for operating the scanner assembly 40, lighting unit 50, DSP 70, user interface 80, and any other electronic equipment associated with the cabinet. Electrical wiring or cables (not shown) between the power supply 90, network hub 99, scanner assemblies 40, lighting units 50, DSP 70, and user interface 80 may be arranged so as to not interfere with operation of the drawers 30.

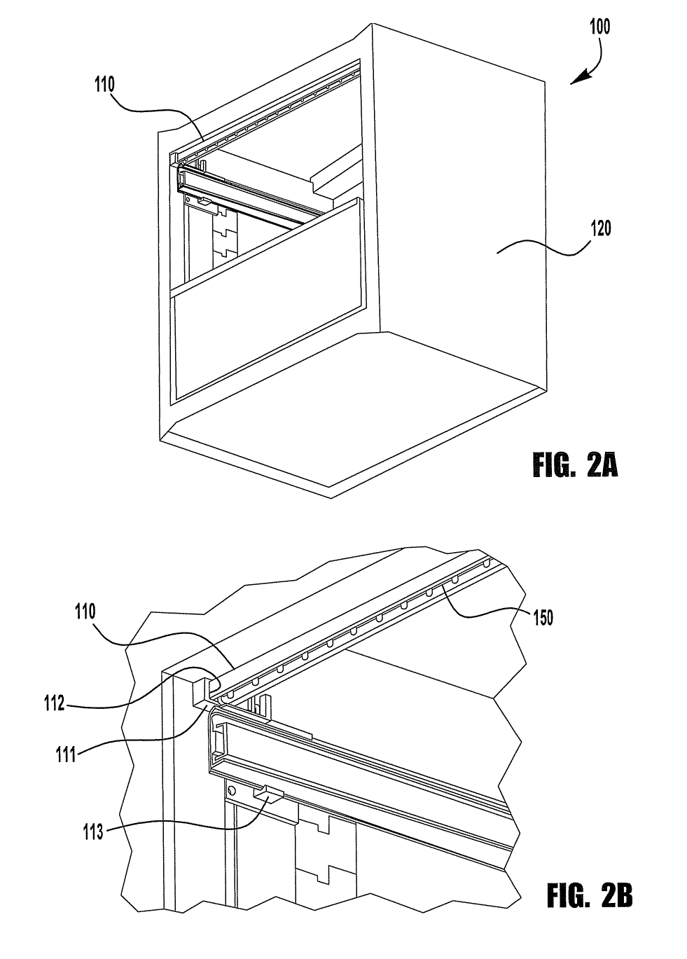

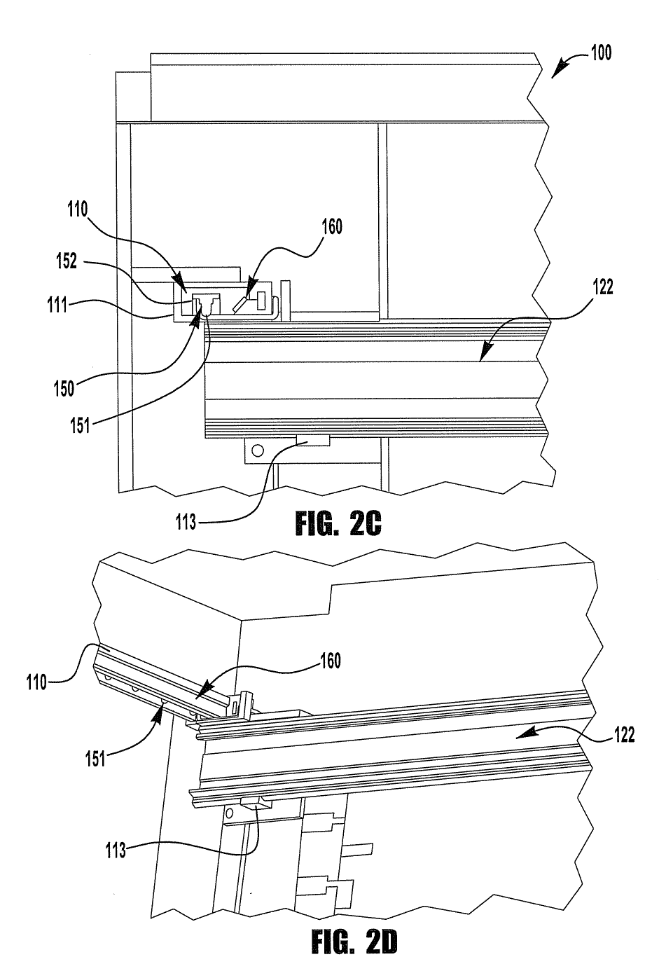

Many different arrangements and configurations may be utilized to provide a storage container with an optical scanning system for automated identification of the contents of the container, to conveniently store and mount the various components of the optical scanning system. In one embodiment, the components and assemblies of an optical scanning system for a storage cabinet may be configured to be used with an existing cabinet, for example, by malting use of common dimensional characteristics of the cabinet. With such an embodiment, an existing storage cabinet may be readily modified or retrofitted to include an optical scanning system for identifying and tracking the contents of one or more drawers in the cabinet. FIGS. 2A-6 illustrate various views of an exemplary tool cabinet 100 having an optical scanner system for identification and tracking of tools stored within the cabinet 100, which may, but need not, be produced by retrofitting an existing tool cabinet.

A lighting unit and mirror element may be secured to a cabinet housing many different configurations and arrangements for reflecting linear images of the contents of a drawer back to an optical scanner. In one embodiment, a lighting unit and mirror element are secured to a rail member extending across the cabinet above a drawer to be scanned. FIGS. 2A-2D illustrate an exemplary embodiment of a cabinet 100 having a horizontal support rail 110 that supports a lighting unit 150 (FIGS. 2B, 2C) and a mirror element 160 (FIGS. 2C, 2D). While the support rail 110 may be secured to the housing 120 using any suitable arrangement, in the illustrated embodiment, a support rail bracket or holder 111 may be provided with a retaining cavity 112 sized to receive an end of the rail 110. The holder 111 may, for example, be secured to the side walls of the housing 120, to the drawer slides 122 (e.g., using clip portions 113), or both. The support rail 110 is positioned to provide sufficient clearance with the corresponding drawer, which may require additional clearance to account for a slight bowing or sagging of the support rail 110 at the lateral center portion of the support rail.

While the rail 110 may secure the mirror element 160 at a variety of angles, in an exemplary embodiment, the mirror element 160 is secured at an angle of approximately 45° with respect to the drawer surface. The mirror element 160 may be secured to the support rail 110 using a high performance adhesive tape (e.g., 3M 468 tape), or any other suitable arrangement. The mirror element 160 may include multiple mirrors secured to the support rail 110, for example, to accommodate wider drawers without requiring longer mirrors. The mirror element, 160 may be provided in any suitable material, including, for example, coated plastic.

Many different types of light sources may be utilized to illuminate the contents of a drawer. In the illustrated embodiment, the lighting unit 150 includes a strip of light emitting diodes (LEDs) 151 mounted to a printed circuit board (PCB) 152 for electrical communication with a power source. The LEDs 151 may provide a relatively long service life with minimal power consumption, for example, to facilitate battery operation. The LEDs 151 may be selected to provide illumination in any of a variety of colors, which may be selected to match the peak sensitivity of the image sensor or to improve the contrast against ambient light sources. In one embodiment, high intensity red-orange LEDs are utilized. The LED arrangement may be configured such that the mounting pitch and the drive current are independent of the drawer width, in order to provide reasonably uniform illumination, at sufficient intensity, on any width of drawer. In one embodiment, each LED has a mounting pitch of approximately 7.5 mm (or 120 LEDs for a 36 inch wide drawer), a drive current of 45 mA (+/−10 mA), and power dissipation of approximately 110 mW. The LEDs may be arranged in chains (e.g., chains of 8-10 LEDs) with the drive current set using a series resistor. Also, to compensate for reductions in reflected intensity and lens performance at locations laterally distal to the scanner 140, the intensity may be increased (e.g., doubled) at these laterally distal locations, for example, by increasing the drive current to these LEDs. Intensity may be gradually increased over the lateral distance between the scanner and the distal end location. In another embodiment, an LED source may be switched on and off more rapidly under software control, and a differential measurement could be taken, to improve rejection or exclusion of ambient light sources.

As shown in FIG. 2C, the LEDs 151 may be secured to the cabinet housing 120 by mounting the PC boards 152 to the rail 110. As shown, the PC boards 152 may be mounted to a recessed surface on the rail 110, for example, to protect the LEDs 151 from damage. The lighting unit 150 may be secured to the support rail 110 using a high performance adhesive tape (e.g., 3M 468 tape), or any other suitable arrangement. In an exemplary embodiment, an LED PC board 152 is approximately 8 mm wide and 200 mm long, and provides space for two chains of up to 10 LEDs. Chains of LEDs varying in number may be combined to accommodate drawers of varying widths.

To limit energy consumption, illumination of the LEDs 151 and scanning by the scanner 140 may be limited to a predetermined time period during which the cabinet 100 is in use, such as, for example, while the cabinet 100 is unlocked, or for a set time period after the cabinet 100 has been unlocked. To further limit energy consumption of the LEDs 151 and scanner 140, an optical scanning arrangement may be provided with a “standby” mode of operation, in which the lighting unit 150 is periodically illuminated and the scanner 140 is signaled to capture one linear image for comparison with a previous standby scanned line. If the sequential scans indicate no significant change, the system “sleeps” until the next standby scan. If a significant change in the linear scans is identified during the next standby scan (consistent with motion of the drawer), the system enters a scanning mode of operation, in which the lighting unit 150 remains illuminated, and the scanner 140 rapidly sends linear scans to the digital signal processor for construction of the two dimensional scanned drawer image. In one such embodiment, the duty cycle of the LEDs may be reduced by a ratio of approximately 30:1 during this standby mode (for example, pulsed once every 20 milliseconds to coincide with a standby scanning frequency).

Where a cabinet includes multiple drawers with optical scanning arrangements, each drawer may autonomously track its own motion status, and transition autonomously from standby to scanning mode and back again. A moving drawer may be given priority on the serial bus, and all other drawer scanners may temporarily stop sending status updates to the central digital signal processor, while the other drawers continue to autonomously monitor whether they are moving, in order to alert the DSP to any drawer movements anywhere in the system, while the DSP is busy processing the data from the first moving drawer. Thus, the DSP can alert the operator to re-scan any drawers that were moved while the first moving drawer was being scanned. Where a single drawer uses multiple scanners (as described in greater detail below), the scanners may be arranged in Master/Slave configurations, with the “master” scanner tracking motion and making transitions between standby and scanning modes, and the “slave” scanner tracking motion while follows the master scanner's operating state transitions. While a variety of intervals may be used, in one embodiment, the lighting unit 150 and scanner 140 are activated every 20 ms while in standby mode, while the scanner 140 obtains a linear image every 1.6 ms while in scanning mode.

Many different types of cameras and sensors may be utilized in a scanner assembly to capture a linear image of a portion of a drawer. In one embodiment, a charge-coupled device (CCD) sensor (e.g., a 2048-pixel line sensor) may be assembled with an image sensor PCB for capturing linear images. One such image sensor is a Sony ILX551. The image sensor PCB may include a CPU configured to generate the necessary timing signals for the CCD sensor, and provide separate serial interfaces to a high speed analog to digital converter (ADC) and to an Ethernet controller to handle communication to the central DSP. An exemplary ADC is a National Semiconductor ADC10321, and an exemplary Ethernet controller is an SMSC LAN9210. The image acquisition time may be generally limited by one or both of the ADC sample rate and the CPU toggle speed. In an exemplary embodiment, the image acquisition time is approximately 700 μs per line.

A lens, such as, for example, a wide angle lens, may be mounted to the CCD sensor at a location configured for optimum focus of the linear image, for example, corresponding with the distance between the sensor and a mirror element reflecting the linear image back to the sensor. The lens may be adjustable to alter the focus, and may be lockable, for example, by a locking screw. Additionally, the lens may be configured to be optimized for the type of light produced by the lighting unit (e.g., optimized for red light, for use with red or red-orange LEDs), and may include a color filter for improved rejection or exclusion of ambient light. Further, the lens design may be simplified by providing monochromatic LED illumination, thereby allowing some wavelength-dependent classes of optical distortion to be ignored for the purposes of this design.

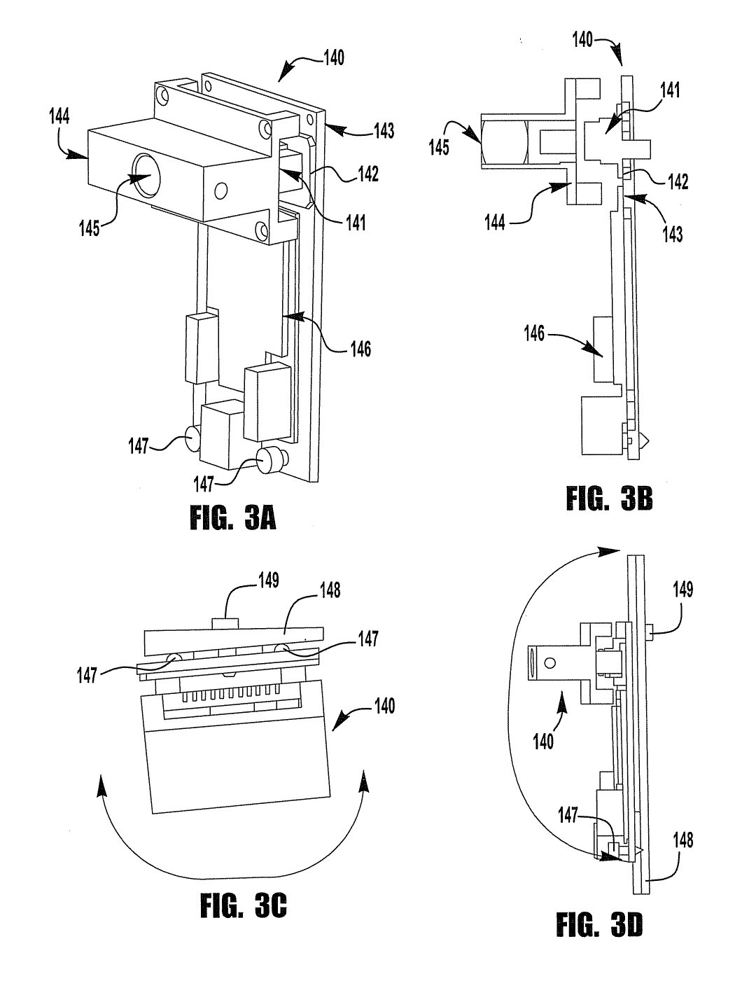

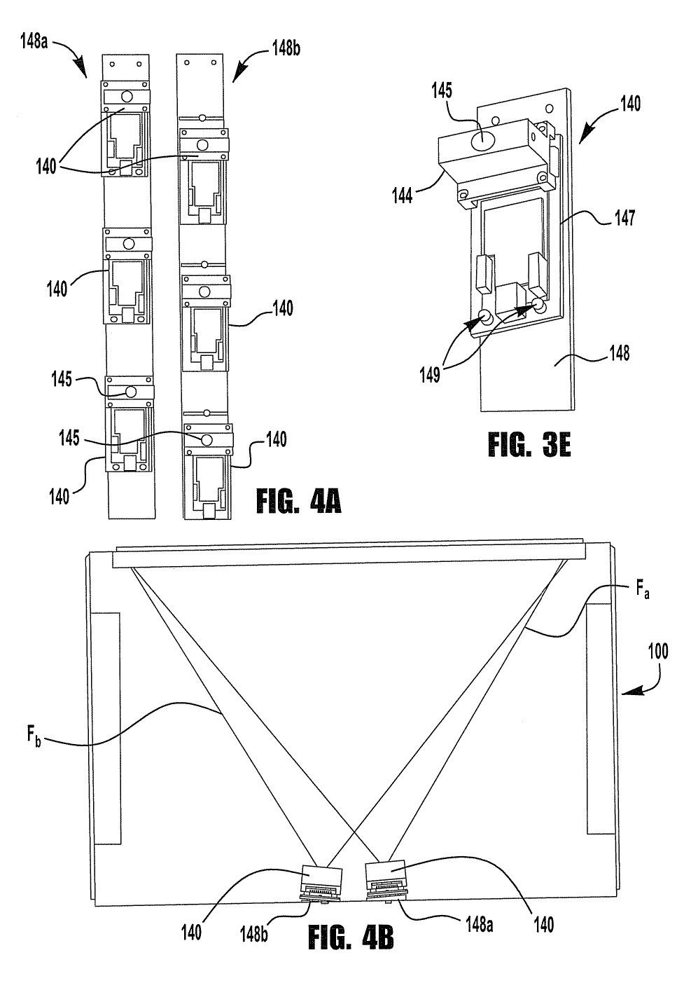

FIGS. 3A and 3B show an exemplary scanner assembly 140 having a CCD sensor 141 and image sensor PCB 142 mounted to a sensor support plate 143, using, for example, screws and shake-proof washers. A lens holder 144 retaining a wide angle lens 145 is adjustably mounted to the sensor support plate 143 (for example, using fasteners, not shown) for optimum focus. The lens 145 may be provided in any suitable size (e.g., 12 mm diameter and 12.5 mm long). The image sensor PCB 142 is electrically connected with a scan module PCB 146, which includes electronic circuitry for controlling the CCD sensor 141 and a lighting unit. The sensor support plate 143 is adapted to be mounted (directly or indirectly) to a rear internal surface of the cabinet housing 120, such that the CCD sensor 141 is directed toward the front of the housing 120.

While the scanner assembly may be centered on the rear wall of the cabinet and directed perpendicular to the cabinet wall, in some embodiments, an off-center position for the scanner may be desirable or required. For example, a cabinet drawer may be too wide to capture an image of the entire drawer using a single scanner assembly (e.g., a drawer with an aspect ratio of greater than 1.6:1, corresponding to the limits of an exemplary wide angle lens). In one such embodiment, multiple scanner assemblies may be utilized to scan the entire width of the drawer (with the digital signal processor being configured to account for any overlap between the corresponding images when constructing a two dimensional image of the drawer).

In other embodiments, a center portion of a cabinet may be utilized for a drawer locking mechanism, which may interfere with an optical scanner if the optical scanner is centered within the cabinet. As such, in one embodiment, a scanner assembly is secured to the rear cabinet wall in a position offset from a center line. To compensate for this off center position, the scanner may be directed at an angle from perpendicular, so that a linear image of the full cabinet drawer width may still be obtained. In the illustrated embodiment, as shown in FIGS. 3C-3E, the sensor support plate 143 is affixed to a scanner support panel 148 fastened to the rear wall of the cabinet housing 120 (for example, using mounting screws), with the support panel 148 having an angled support surface configured to position the CCD sensor 141 at a desired angle from perpendicular. While many different angles may be utilized (and may be selected for optimum scanning), in one embodiment, the sensor 141 is positioned at an angle of approximately 5° from perpendicular. Additionally, as shown, the scanner assembly 140 may be provided with adjustment screws 147, 149 (or other such mechanisms) to allow for manual adjustment of the angle of the CCD sensor 141 about horizontal and vertical axes (coplanar with the support plate 143), for example, to adjust or optimize the drawer image obtained by the scanner, as shown in FIGS. 3C and 3D. Further, the rotational position of the image sensor about an axis perpendicular to the support plate 143 may be adjustable to align the field of vision of the lens 145 to be parallel to the mirror element 160.

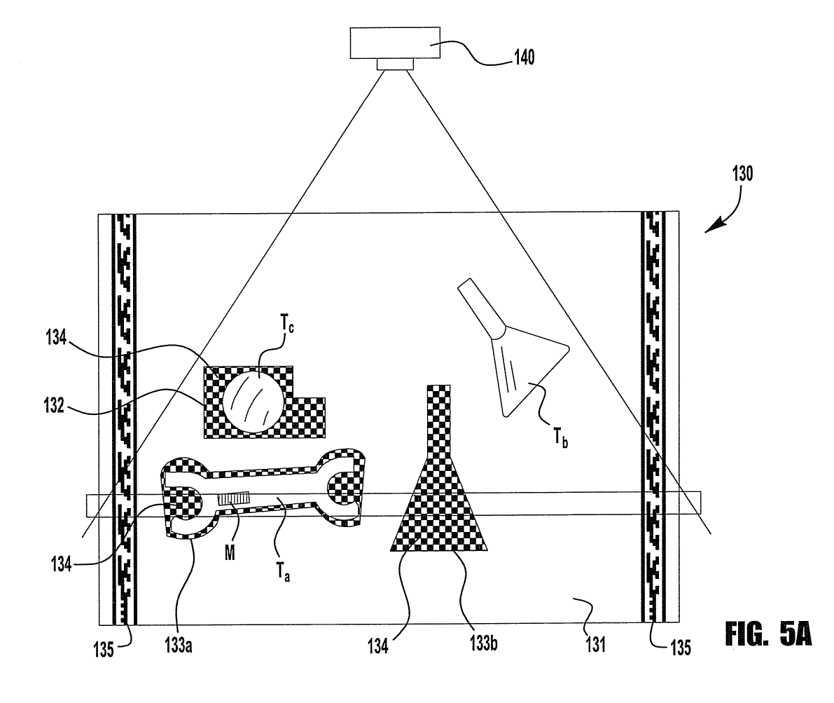

In some embodiments, use of scanner assemblies with multiple drawers to be scanned, depending on the size and spacing of the drawers, may require that the positions of the scanner assemblies be staggered on the rear wall of the housing to provide sufficient clearance for each scanner assembly. FIG. 4A illustrates left and right support panels 148a, 148b supporting multiple optical scanner assemblies 140 in a staggered arrangement, allowing for vertical overlap of the scanner assemblies 140 within the cabinet 10, for example, to accommodate adjacent narrow drawers to be scanned by allowing for minimal vertical spacing (e.g., 2 inches) between lenses 145. As shown in FIG. 4B, the opposed angled mounting surfaces of the support panels 148a, 148b allows the optical scanner assemblies 140 mounted to either side of the cabinet center line to obtain linear images of a full width of a drawer enclosure (as shown by the fields of view identified at Fₐ and F_{b}).

While objects may be placed in a drawer in any number of locations or arrangements, in one embodiment, a drawer may include separate compartments or recesses to organize the stored objects and prevent overlap of the objects, which could make it difficult for a processor to identify the objects. In one such embodiment, compartments or recesses in a drawer may be specifically shaped, sized, or otherwise coded (e.g., color coding or marking with the name or part number of an object) to receive specific objects. This may allow for simplification of the software, algorithms, or other processes of a digital signal processor to identify the stored objects, by allowing the processor to check for a specific known object at a predetermined location.

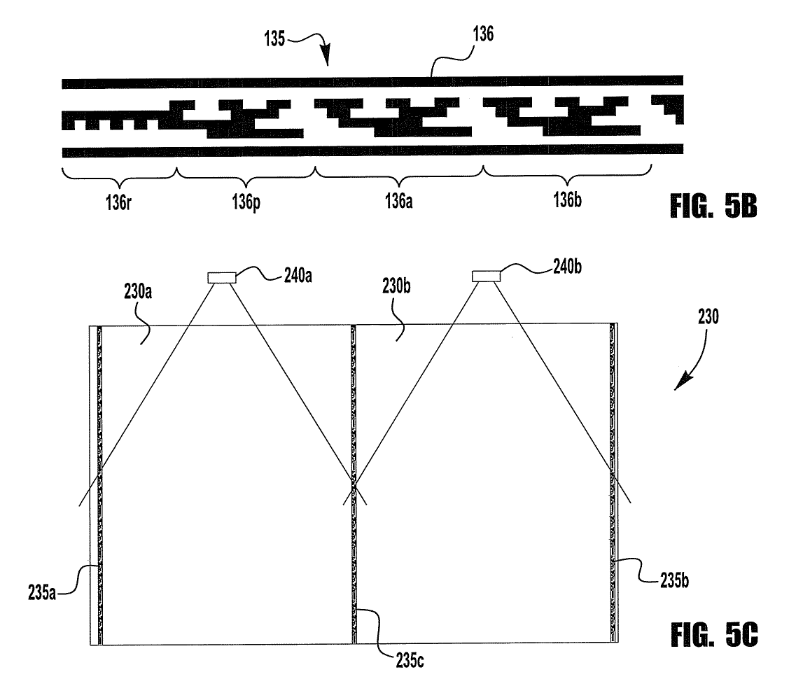

FIG. 5A illustrates a top schematic view of an exemplary drawer 130 configured to receive a plurality of objects for scanning, identification, and storage. The drawer 130 includes an insert 131 defining a plurality of recesses 133a-133c each sized and shaped to receive an object for storage. As shown, the recesses 133a-c may, but need not, be shaped to match an outer perimeter of an object to be stored and scanned, for example, to ensure a desired orientation of the properly stored object to facilitate scanning. Further, the recesses 133a-c may be sized to closely receive an intended object, for example, to minimize variance in the position of the properly stored object (e.g., within 2 mm in lateral and longitudinal horizontal directions) to facilitate comparison of the scanned images with stored templates. While the insert 131 may be provided in a variety of materials, in one embodiment, the insert 131 is provided in a foam material, which may be easily cut to form the recesses 133a-133c.

When the scanner 140 scans an image of the drawer 130, the associated digital signal processor may analyze the entire two dimensional image of the drawer 130. Alternatively, the processor may analyze only specific regions of the drawer 130, such as, for example, the recessed portions 133a-133c, for example, to simplify the software, processes, and algorithms required to perform the analysis. For example, analysis of these recessed portions may identify an object Tₐ properly stored in a recess 133a, an object missing from a recess 133b, or an incorrect object T_{c} stored in a recess 133c. As another alternative, the processor may be configured to more fully analyze regions of greater interest (e.g., the recesses 133a-133c), while only checking for unexpected visual characteristics (e.g., consistent with an object T_{b} stored out of its recess 133b) on the remainder of the drawer surface (with more detailed subsequent analysis if necessary or desirable). In one embodiment, the non-recessed portions of the drawer surface may be provided in a solid color, such that processor recognition of contrast on these portions may be used to identify foreign or out of position objects.

Determination of an overall shape of an object may be used to verify the presence of the correct objects in a cabinet drawer. In another embodiment, the processor may additionally or alternatively be configured to analyze markings on an object to facilitate object identification (e.g., by comparing the image of the marking with markings corresponding to known objects). These markings may include, for example, bar codes, character strings, part numbers, or logos, which may be marked on one or more locations on the object. As shown, a marking M may be positioned on an object Tₐ to be scannable when the object is properly stored and oriented in its intended recess 133a.

Many objects may be easily identified by an optical scanner based on their color, shape, or other identifying visual characteristics. However, optical scanning of highly reflective objects (such as, for example, chrome tools) may be difficult, as light reflected from the object may produce unpredictable contrasts on the surface of the object. In one embodiment, a background surface upon which an object is placed may be patterned to provide a regular, predictable contrast pattern against which the object may be compared. The digital signal processor may be programmed to recognize the background pattern, and to analyze the scanned image for gaps, breaks, or interruptions in this known background pattern, consistent with a position being occupied by a stored object. As one example, a small repeating checkerboard pattern (e.g., having a pitch of approximately 5 mm) may be utilized on the background surface of the drawer. As shown in FIG. 5A, the drawer recesses 133a-133c may include patterned background surfaces 134 against which the shape of a stored object Tₐ, T_{c} may be more easily recognized (e.g., by comparing background portions of a known high resolution contrast with object portions exhibiting more gradual contrast).

To produce a two dimensional image from a series of sequential linear images, a processor may determine the position of a given linear image based on a constant rate of movement of the scanned surface with respect to the scanner, as is done with a conventional document scanner. In one embodiment, a drawer to be scanned may open and/or close at a constant rate of speed, for example, by using a motorized mechanism, thereby facilitating construction of a corresponding two dimensional image of the drawer. However, where the rate of movement of the scanned surface with respect to the scanner varies, as would be the case with the manual opening and closing of a cabinet drawer to be scanned, other arrangements may be required to identify the portion of the drawer to which each linear image corresponds, such that the two dimensional image of the drawer may be constructed.

In one embodiment, an incremental or absolute encoder (e.g., mechanical, optical, or magnetoresistive encoders) may be used to provide a signal to the processor identifying the location on the drawer of each recorded linear image, based on the position of the drawer. In another embodiment, the surface of the drawer being scanned may be provided with a marked portion configured to facilitate processor identification of the location of a linear image of a portion of the drawer. As one example, one or more coded or patterned calibration strips (fixed relative to the support surface, for example, within 0.5 mm of a known position) may be provided along the length of the drawer surface, such that each linear image captures a portion of the coded strips, which the digital signal processor may use to identify the location on the drawer to which the linear image corresponds, for construction of a two dimensional image of the drawer. In the illustrated embodiment of FIG. 5A, coded strips 135 are provided on both sides of the drawer 130 for independent identification of the positions of the scanned portions at both sides of the drawer 130, to account for any skew of the drawer with respect to the scanner 140, or to allow for continued scanning in the event that one of the coded strips becomes damaged or obstructed.

While a coded strip 135 may include many types of calibrated markings for identification by an optical scanner, in one embodiment, a coded strip includes a repeating Gray-coded multi-step black and white pattern by which an unambiguous absolute position within the multi-step range is identified by the scanner by the portion of the multi-step pattern included in the linear image generated by the scanner 140. In the illustrated example, a 4 bit, 14 step code 136a, 136b of the pattern 136 allows for identification of a location of the linear image within that 14 step range. In one such embodiment, each step is approximately 1 mm, such that the linear image may be located within a 14 nm range using only the portion of the code in the linear image. Other sizes and step ranges of coded patterns may be utilized.

To determine which portion 136a, 136b of the pattern 136 the linear image corresponds to, the processor may utilize a software counter that increments or decrements the repeating codes, such that the exact drawer position of the linear image can be determined using a combination of the counted codes and the portion of the code in the linear image. Additionally, a separate reference code 136r, distinguishable from the repeating codes 136a, 136b of the pattern, may be used to identify an initial closed reference position of the drawer 130, for example, when power to the cabinet is cycled (i.e., a meaningful processor count of the codes 136a, 136b is not available). The portion of the drawer 130 that is longitudinally aligned with the reference code 136r may be intentionally configured to exclude placement of objects (e.g., by not having recesses 133a-c extend into this portion) to allow for a consistent reference linear image. The reference code 136r may be followed immediately by a full or partial code 136p to identify the corresponding locations of linear images captured upon movement of the drawer 130 towards an open or extended position. To accommodate drawers of varying lengths, a code strip 135 having the reference code 136r at a first end may be cut at a second end of the strip at a length corresponding to the length of the drawer.

To scan the contents of a wider drawer, multiple scanners may be used, with each scanner capturing laterally adjacent portions of the drawer. FIG. 5C illustrates a top schematic view of an exemplary drawer 230 having first and second laterally adjacent regions 230a, 230b configured to receive a plurality of objects for scanning, identification, and storage. The drawer 230 may includes an insert with recesses having patterned support surfaces (not shown), consistent with the drawer 130 of FIG. 5A. Scanners 240a, 240b are laterally positioned to capture images of the corresponding regions 230a, 230b, and the corresponding recorded data from each scanner may be processed separately (i.e., as if scanning the contents of two separate, narrower drawers). To identify the location within each region 230a, 230b of each recorded linear image, the drawer 230 may be provided with three coded calibration strips 235a, 235b, 235c (e.g., the coded strips described in greater detail above), with one coded strip on each side and one separating the two drawer regions 230a, 230b. In such an arrangement, the center code strip 235c may also identify the lateral boundary separating the drawer regions 230a, 230b.

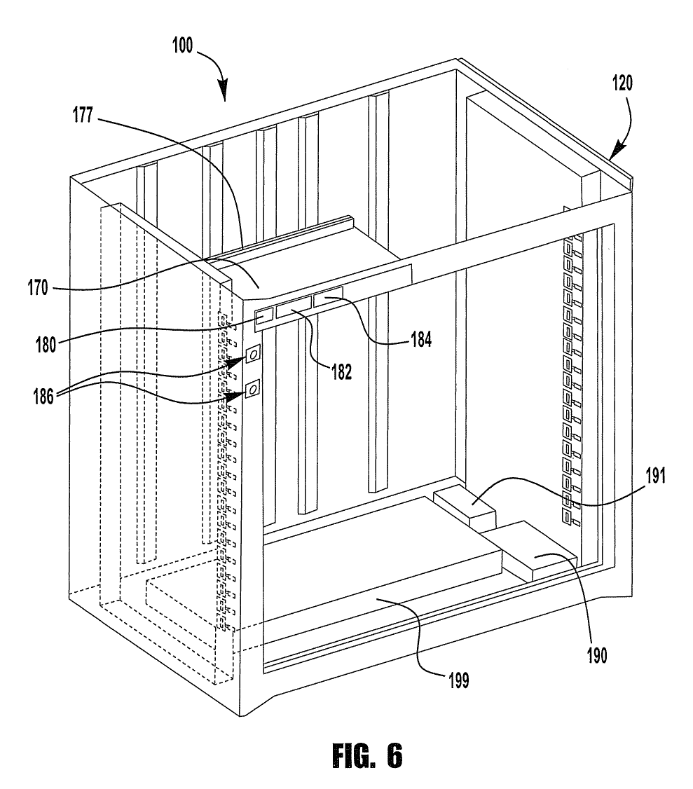

Electrical subsystem components for powering and controlling an optical scanning system in a cabinet may be provided in a variety of configurations, and may be retained in a variety of locations inside or outside of the cabinet enclosure. In one embodiment, the electrical subsystem may be adapted for inclusion in an existing tool cabinet (e.g., by making use of common available spaces, panels, and dimensions), such that the existing cabinet may be readily retrofitted to include one or more optical scanning systems. FIG. 6 illustrates a perspective view of the housing 120 and electrical subsystem of the exemplary cabinet 100, with the housing 120 shown in phantom to better illustrate the electrical subsystem components. As shown, the digital signal processor 170 may be mounted to an upper front portion of the cabinet enclosure, for example, by securing a support bracket 177 to the housing 120. The support bracket 177 may also support a user interface 180, which may include, for example, a display screen 182 (e.g., an LCD display) and keypad 184. Other user interface components may be provided, such as, for example, a speaker or biometric sensor. Drawer indicators 186 may be provided next to each drawer (or any other suitable location), to provide an indication related to usage of the optical scanning system (e.g., a successful or unsuccessful scan). As shown, the drawer indicators 186 may include LEDs mounted to PC boards secured to the cabinet housing 120 (for example, using a bracket or other mounting hardware). A power supply 190 may be stored, for example, at the bottom of the cabinet enclosure for converting source AC power to an appropriate DC power (e.g., 24 VDC) for operating the scanner assemblies, lighting units, and other electrical components. As shown, a separate power supply unit 191 may be provided to operate the digital signal processor 170, for example, to deliver a different voltage to the DSP (e.g., 5 VDC). Alternatively, the power supply unit may be configured to provide varying DC voltages to operate the various electrical components. A networking hub 199 (e.g., an Ethernet hub) may be included to connect the DSP 170 with each optical scanning assembly, and may also include ports (e.g., USB ports) for connection to an external computer or other such device, for example, for data analysis or system debugging. Additionally, a memory card, such as, for example, an SD memory card, may be utilized with the DSP 170 to provide increased memory for stored templates and debugging operations.

The electronic system associated with an optical scanning storage enclosure may be configured to provide a variety of security and tracking features. For example, to determine an individual responsible for a lost item from a container having an optical scanning system, the container (such as a tool cabinet) may be configured to require electronic identification of the user of the container at the time the container is opened and contents are removed, and/or after contents are returned to the container and the container has been closed. As such, the container may include an electronic lock configured to require some type of user-specific electronic input on a user interface (for example, entry of an access code, insertion or swiping of an electronic key card, or biometric scanning of a unique characteristic, such as a fingerprint) prior to opening the container, thereby allowing the inventory management system to identify the individual using the container and any of its contents. When the items are returned to the drawer and the drawer is moved from the opened position to the closed position, optical scanning of the drawer produces a two dimensional image for comparison with a previous image of the drawer, or images of one or more items intended to be stored in the cabinet, to identify if any items are missing or improperly stored, or were replaced with the wrong item. The electronic system may be configured to provide instant and automatic alerts of such discrepancies, for example, by providing an audible or visual output at the user interface, or by delivering a corresponding alert signal to an external computer or electronic security system. The electronic system may also be configured to provide a time stamp with user identification and/or scan of the drawer contents.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A method for identifying an object comprising:
placing an object on a support surface of a receptacle, the support surface including a repeating contrasting pattern;
optically scanning the support surface to produce a digital image of the support surface;
analyzing the digital image to identify portions of the repeating contrasting pattern interrupted by the object;
determining a shape of the object from the interrupted portions of the repeating contrasting pattern; and
comparing the determined shape of the object to stored data corresponding to predetermined shapes of known objects to identify the object.

2. The method of claim 1, wherein optically scanning the support surface to produce a digital image of the support surface comprises moving the support surface relative to an optical scanning device to produce a series of linear images, and compiling the linear images to produce the digital image.

3. The method of claim 2, wherein optically scanning the support surface further comprises optically scanning a calibration pattern proximate to the support surface, such that each one of the series of linear images includes a portion of the calibration pattern sufficient to identify a corresponding location of each one of the series of linear images.

4. The method of claim 1, further comprising directing a light source toward the support surface, wherein optically scanning the support surface comprises recording light from the light source reflected off the support surface and the object.

5. The method of claim 4, further comprising redirecting light reflected off the support surface and the object toward an optical scanning device using a mirror.

6. An object identifying system comprising:
an enclosure including a rear wall, first and second laterally spaced side walls, a top wall, and a front opening opposite the rear wall;
a drawer including a support surface for retaining at least one object, with at least a portion of the support surface including a repeating contrasting pattern, the drawer being assembled with the enclosure and movable between a retracted position in which the support surface is surrounded by the enclosure and an extended position in which the support surface extends from the front opening and is accessible for placement or removal of the at least one object;
an optical scanning device disposed within the enclosure proximate the rear wall;
a mirror secured to the enclosure proximate the front opening and above the support surface of the drawer, the mirror being oriented to redirect light reflected from a portion of the support surface under the mirror toward the optical scanning device; and
a processor in electrical communication with the optical scanning device;
wherein the optical scanning device is configured to record a series of linear images of successive portions of the support surface under the mirror when the drawer is moved between the retracted position and the extended position;
further wherein the processor is configured to compile data corresponding to the series of linear images of the successive portions of the support surface to construct a digital image of the support surface, the processor further being configured to compare the digital image of the support surface to at least one stored digital image of a known object to identify an object when the object is disposed on the support surface.

7. The object identifying system of claim 6, further comprising a support rail extending between the first and second sides of the enclosure, the mirror being supported by the rail.

8. The object identifying system of claim 7, further comprising a light source secured to the support rail, the light source being oriented to direct light toward a portion of the support surface directly below the mirror.

9. The object identifying system of claim 8, wherein the light source comprises a plurality of light emitting diodes in electrical communication with the processor.

10. The object identifying system of claim 9, wherein the plurality of light emitting diodes are configured to be pulsed at a first duty cycle when the drawer is stationary and at a second duty cycle greater than the first duty cycle when the processor detects movement of the drawer.

11. The object identifying system of claim 9, wherein the plurality of light emitting diodes are configured to be pulsed in synchronization with operation of the optical scanning device.

12. The object identifying system of claim 8, wherein the light source is arranged to provide a greater illumination intensity at positions laterally distal to the optical scanning device and a lesser illumination intensity at a position laterally aligned with the optical scanning device.

13. The object identifying system of claim 6, wherein the optical scanning device comprises an optical sensor and a lens secured to a support plate, the support plate being mounted to an internal surface of the rear wall of the enclosure.

14. The object identifying system of claim 13, wherein the optical scanning device further comprises at least one adjustment screw operable to adjust an orientation of the lens with respect to at least one of a horizontal axis parallel to the support surface and a vertical axis parallel to the rear wall.

15. The object identifying system of claim 13, wherein the optical scanning device is disposed at a position offset from a lateral centerline of the support surface, the optical scanning device being oriented at an angle with respect to the lateral centerline to compensate for the offset position.

16. The object identifying system of claim 6, comprising first and second drawers and first and second optical scanning devices for scanning a corresponding one of the first and second drawers.

17. The object identifying system of claim 6, comprising first and second support surfaces on the drawer and first and second optical scanning devices for scanning a corresponding one of the first and second support surfaces.

18. The object identifying system of claim 6, wherein the support surface comprises a recess in the drawer, the recess being shaped to receive the at least one object in a desired orientation.

19. The object identifying system of claim 6, wherein the processor is configured to determine the shape of the at least one object placed on the support surface by analyzing portions of the repeating contrasting pattern interrupted by the at least one object.

20. An object identifying system comprising:
an enclosure including a rear wall, first and second laterally spaced side walls, a top wall, and a front opening opposite the rear wall;
a first drawer assembled with the enclosure and including a first support surface for retaining at least a first object with at least a portion of the first support surface including a repeating contrasting pattern, the first drawer being movable between a retracted position in which the first support surface is surrounded by the enclosure and an extended position in which the first support surface extends from the front opening and is accessible for placement or removal of the first object;
a second drawer assembled with the enclosure and including a second support surface for retaining at least a second object with at least a portion of the second support surface including a repeating contrasting pattern, the second drawer being movable between a retracted position in which the second support surface is surrounded by the enclosure and an extended position in which the second support surface extends from the front opening and is accessible for placement or removal of the second object;
a first optical scanning arrangement disposed within the enclosure and configured to record a series of linear images of successive portions of the first support surface when the first drawer is moved between the retracted position and the extended position;
a second optical scanning arrangement disposed within the enclosure and configured to record a series of linear images of successive portions of the second support surface when the second drawer is moved between the retracted position and the extended position; and
a processor in electrical communication with the first and second optical scanning devices, wherein the processor is configured to compile data corresponding to the series of linear images of the successive portions of the first and second support surface to construct a digital images of the first and second support surfaces, the processor further being configured to compare the digital images of the first and second support surfaces to at least one stored digital image of a known object to identify an object when the object is disposed on either one of the first and second support surfaces.

21. An object identifying system comprising:
an enclosure including a rear wall, first and second laterally spaced side walls, a top wall, and a front opening opposite the rear wall;
a drawer assembled with the enclosure and including first and second laterally adjacent support surface for retaining at least corresponding first and second objects, with at least a portion of each of the first and second support surfaces including a repeating contrasting pattern, the drawer being movable between a retracted position in which the first and second support surfaces are surrounded by the enclosure and an extended position in which the first and second support surfaces extend from the front opening and are accessible for placement or removal of the first and second objects;
first and second optical scanning devices disposed within the enclosure proximate the rear wall;
a mirror secured to the enclosure proximate the front opening and above the first and second support surface of the drawer, the mirror being oriented to redirect light reflected from portions of the first and second support surfaces under the mirror toward a corresponding one of the first and second optical scanning devices; and
a processor in electrical communication with the optical scanning device;
wherein the first and second optical scanning devices are each configured to record a series of linear images of successive portions of the corresponding one of the first and second support surfaces under the mirror when the drawer is moved between the retracted position and the extended position; and
further wherein the processor is configured to compile data corresponding to the series of linear images of the successive portions of the first and second support surfaces to construct digital images of the first and second support surfaces, the processor further being configured to compare the digital images of the first and second support surfaces to at least one stored digital image of a known object to identify an object when the object is disposed on the support surface.
